(19) United States
(12) Patent Application Publication
(10) Pub. No.: US 2006/0272866 A1
(43) Pub. Date: Dec. 7, 2006

(54) Tandem axle system

(76) Inventor: James F. Ziech, Kalamazoo, MI (US)

Correspondence Address: MARSHALL & MELHORN, FOUR SEAGATE, EIGHT FLOOR, TOLEDO, OH, 43604, US

(21) Appl. No.: 11/146,739

(22) Filed: Jun. 7, 2005

(51) Int. Cl. B62D 61/10

(52) U.S. Cl. 180/24.1

(57) ABSTRACT

A tandem axle system for a vehicle has a forward drive assembly selectively connected to a rear drive assembly. The forward drive assembly provides constant drive to a forward axle. The rear drive assembly is selectively connected to the forward drive assembly via at least one clutch. Engagement or disengagement of the at least one clutch provides drive to a rear axle or allows the rear axle to idle, respectively.

### FIELD OF THE INVENTION

The present invention relates to tandem axle systems for vehicles. More specifically, the present invention relates to tandem axle systems for vehicles having a first driven axle and a second, selectively driven axle.

### BACKGROUND OF THE INVENTION

Those skilled in the art know that traditional tandem axle drivelines of trucks comprise 6×4 drivelines (i.e., 2 wheels on the steer axle and 4 driving wheels on tandem axles behind the steer axle) or 6×2 drivelines (i.e., 2 wheels on the steer axle and 4 wheels on the tandem axles behind the steer axle where only two wheels are on a drive axle).

The 6×2 drivelines are often undesirable since they lack the needed tractive effort under poor traction conditions.

The 6×4 drivelines can be undesirable since they can be inefficient, costly and heavy. They are inefficient due to the windage loss of rotating gears in oil. The cost and weight associated with 6×4 drivelines can be, at least partially, attributable to the inter-axle differentials and helical drop gears as well as wheel differentials.

The 6×4 drivelines are also undesirable since, under most driving traction coefficient conditions, two drive axles are not required to develop the necessary tractive effort for a truck, such as a Class 8 truck.

Various patents depict and describe attempts by others to disengage one of the two drive axles of a 6×4 tandem when it is not needed. For example, U.S. Pat. No. 5,711,389 teaches that the forward axle of the tandem can be selectively engaged or disengaged by a disk-type friction clutch or clutch pack. The rear axle of the tandem is always driven by a through shaft.

U.S. Pat. No. 1,927,276 teaches a clutch member designed to engage and disengage a through shaft. The through shaft drives an inter-axle shaft connected to a rear axle. A drop gear set is used to provide drive to the forward axle.

U.S. Pat. No. 2,064,262 describes a forward drive axle and a rear drive axle that are substantially similar. Both drive axles have a selectively operable clutch comprising a slidable collar. A collar is mounted on splines of the output shaft of the forward drive axle and can slide onto splines on a through shaft. The through shaft provides drive to the rear drive axle. Joining the output shaft of the forward drive axle with the through shaft via the collar connects the forward drive axle and the rear drive axle. Sliding the collar either off of the splines of the through shaft or the output shaft disconnects the forward drive axle and the rear drive axle.

U.S. Pat. No. 4,046,210 teaches a clutch mechanism located in the forward drive axle designed to selectively connect and disconnect the forward drive axle with the rear drive axle. The clutch mechanism comprises a clutch gear mounted on splines of a through shaft. The clutch gear is selectively moveable on the splines into and out of engagement with a clutch gear on the input shaft. A drop gear set, located forward of the clutch mechanism, provides drive from the input shaft to the forward drive axle.

In light of the disadvantages of the representative prior art discussed above, it would be desirable for a tandem axle drive system to eliminate the interaxle differential, the rear axle wheel differential and the drop gear set in the forward axle yet which allows the forward axle to selectively provide drive to the rear axle and allows the rear axle of the tandem to idle when not driven.

### SUMMARY OF THE INVENTION

The present invention is a tandem axle system for a vehicle comprising a forward drive assembly having a forward input shaft and a forward pinion gear axially aligned with and connected to the forward input shaft. The forward pinion gear directly drives a forward ring gear via a hypoid engagement. A rear drive assembly has a rear pinion gear where the rear pinion gear is connected to a rear ring gear. The rear drive assembly is selectively connected to the forward drive assembly.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a top, schematic view of a vehicle of the present invention;

FIG. 2 is a partial, schematic side view of a forward drive assembly;

FIG. 3 is a partial, schematic side view of another forward drive assembly of the present invention;

FIG. 4 is a partial, schematic side view of another forward drive assembly of the present invention;

FIG. 5 is a partial, schematic top view of a rear drive assembly of the present invention; and

FIG. 6 is a partial, schematic top view of another rear drive assembly of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

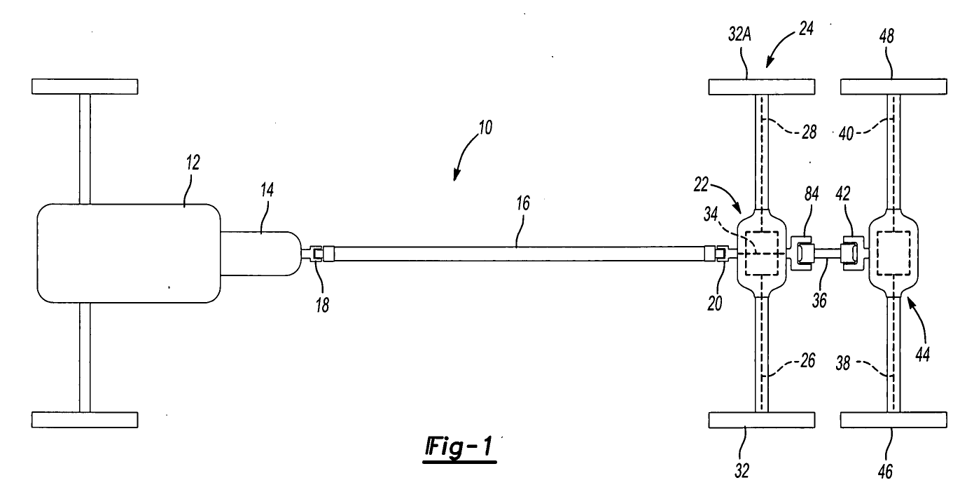

Referring now to FIG. 1, a vehicle 10 having an engine 12 drivingly connected to a change speed transmission 14 is depicted. A shaft 16 is connected to the output portion of the transmission 14, such as by a yoke 18 as known to those skilled in the art, and is drivingly connected to an input, such as by a yoke 20 also as known to those skilled in the art, of a forward drive axle housing 22 of tandem axles 24.

As described in more detail below, drive is transmitted from the yoke 20 to a first forward drive axle 26 and a second forward drive axle 28 located within the forward drive axle housing 22. The first forward drive axle 26 and the second forward drive axle 28 are half shafts as known to those skilled in the art. The first forward drive axle 26 provides drive to at least one wheel 32 and associated tire (not shown) and the second forward drive axle provides drive to at least one wheel 32A and associated tire (not shown), as known to those skilled in the art.

A through shaft, numbered generically with reference number 34, extends through the forward drive axle housing 22 and is drivingly connected to an inter-axle driveline 36. The inter-axle driveline 36 connects the forward drive axles 26, 28 with a first rear drive axle 38 and a second rear drive axle 40. More specifically, the inter-axle driveline 36 transmits drive to an input, such as a yoke 42, as known to those skilled in the art, for the rear drive axles 38, 40. The rear drive axles 38, 40 are located within a rear drive axle housing 44. The drive axles 38, 40 are half shafts as known to those skilled in the art. The first rear drive axle 38 provides drive to at least one wheel 46 and associated tire (not shown) and the second rear drive axle 40 provides drive to at least one wheel 48 and associated tire (not shown), as known to those skilled in the art.

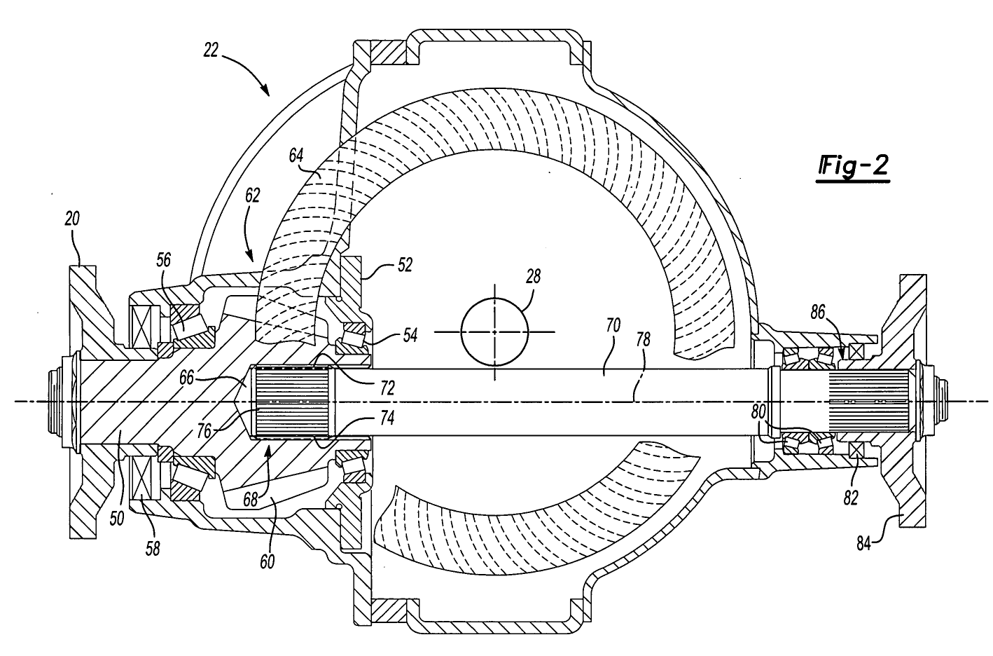

Turning now to FIG. 2, one embodiment of selected components of the forward drive axle housing 22 is depicted. One half of the yoke 20 connecting the forward drive axles 26, 28 with the shaft 16 is depicted. The yoke 20 is mounted on an input shaft 50. The input shaft 50 is mounted for rotation within the forward drive axle housing 22 on at least two bearings. A bearing cage 52, as known to those skilled in the art, may be secured to the housing 22. The bearing cage 52 supports one of the bearings called an inner pinion bearing 54. An outer pinion bearing 56 comprises the second bearing.

A seal 58, as known by those skilled in the art, is located about the input shaft 50 to prevent dirt and debris from entering the forward drive axle housing 22 and from lubricant (not shown) located within the forward drive axle housing 22 from escaping.

The input shaft 50 is integrally formed with a pinion gear 60, thus axially aligning the pinion gear 60 with the input shaft 50. Those skilled in the art will appreciate that a non-integrally formed input shaft and pinion gear are also within the scope of the present invention.

The pinion gear 60 is part of a hypoid gear set 62 also comprising a ring gear 64. The ring gear 64 is drivingly connected to a differential case (not shown), as known by those skilled in the art. The differential case is connected to a differential spider (not shown) having at least one shaft with pinions located on the ends of the shaft. The pin ions are connected to side gears (not shown), which are connected to the first and second forward drive axles 26, 28. Thus, drive is provided to the first and second forward drive axles 26, 28 as described above and as known by those skilled in the art.

As shown in FIG. 2, the pinion gear 60 has a recess 66 for receiving a portion 68 of a through shaft 70. The through shaft 70 may be secured within the recess 66 of the pinion gear 60 with mechanical fasteners, welding or the like. It is preferred, however, that a first set of splines 72 in an interior portion 74 of the recess 66 mate with a second set of splines 76 on the through shaft 70. Regardless of the method used to join the through shaft 70 and the pinion gear 60, it is preferable that the pinion gear 60 provides rotational drive to the through shaft 70.

Based on FIG. 2, it can be appreciated that the input shaft 50, the pinion gear 60 and the through shaft 70 share the same axis of rotation 78.

The through shaft 70 extends across the forward drive axle housing 22. Preferably, the through shaft 70 extends under the second forward drive axle 28, as shown in FIG. 2.

Those skilled in the art will appreciate that the differential spider, pinions and side gears discussed above may have to be offset to one side of the forward drive axle housing 22 to provide sufficient clearance for the through shaft 70. The through shaft 70 is supported for rotation with respect to the forward drive axle housing 22 on at least one rear bearing. Preferably, two rear bearings 80 support through shaft 70. A seal 82 is located outwardly from the bearings 80 to prevent lubricant (not shown) from escaping from the forward drive axle housing 22 and to prevent dirt and debris from entering the forward drive axle housing 22.

A yoke 84 is preferably attached to a portion 86 of the through shaft 70, as known by those skilled in the art. The yoke 84 is connected to the inter-axle driveline 36 described above and depicted in FIG. 1.

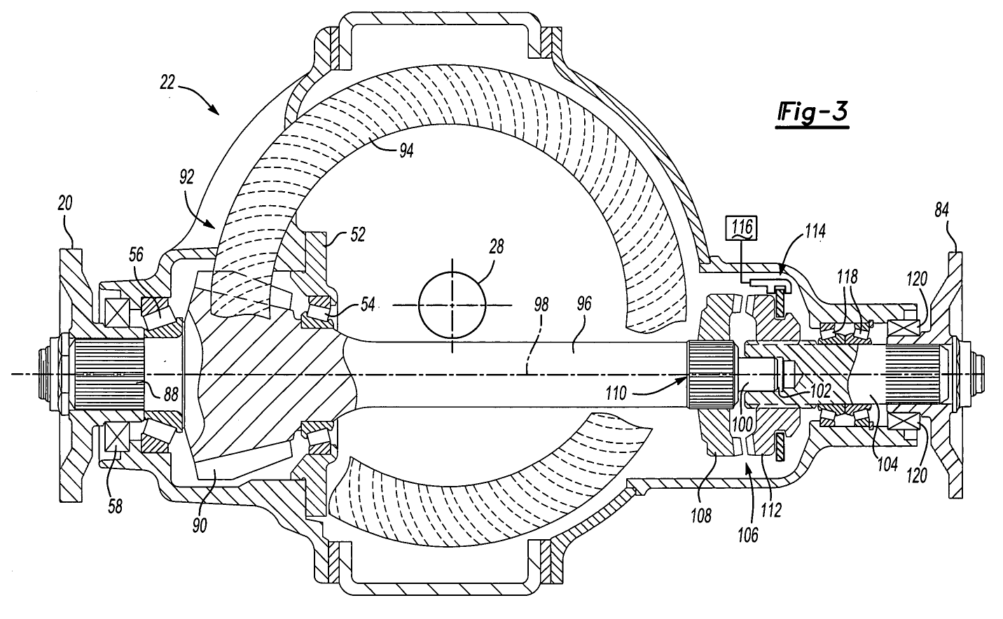

Referring now to FIG. 3, another embodiment of selected components of the forward drive axle housing 22 is depicted. Reference numbers used in FIG. 3 for like components discussed above and depicted in FIG. 2 will be used for the depicted present embodiment. One half of the yoke 20 connecting the forward drive axles 26, 28 with the shaft 16 is depicted. The yoke 20 is mounted on an input shaft 88. The input shaft 88 is mounted for rotation within the forward drive axle housing 22 on at least two bearings. A bearing cage 52, as known to those skilled in the art, may be secured to the housing 22. The bearing cage 52 supports one of the bearings called an inner pinion bearing 54. An outer pinion bearing 56 comprises the other bearing.

A seal 58, as known by those skilled in the art, is located about the input shaft 88 to prevent dirt and debris from entering the forward drive axle housing 22 and to prevent lubricant (not shown) located within the forward drive axle housing 22 from escaping.

The input shaft 88 is integrally formed with a pinion gear 90, thus axially aligning the pinion gear 90 with the input shaft 88. Those skilled in the art will appreciate that a non-integrally formed input shaft 88 and pinion gear 90 are also within the scope of the present invention.

The pinion gear 90 is part of a hypoid gear set 92 also comprising a ring gear 94. The ring gear 94 is drivingly connected to a differential case (not shown), as known by those skilled in the art. The differential case is connected to a differential spider (not shown) having at least one shaft with pinions located on the ends of the shaft. The pinions are connected to side gears (not shown), which are connected to the first and second forward drive axles 26, 28. Thus, drive is provided to the first and second forward drive axles 26, 28 as described above and as known by those skilled in the art.

As shown in FIG. 3, the pinion gear 90 and a through shaft 96 are integrally formed. It can be appreciated, based on FIG. 3, that the input shaft 88, the pinion gear 90 and the through shaft 96 preferably share the same axis of rotation 98. The input shaft 88 drives the pinion gear 90 and the through shaft 96.

The through shaft 96 extends across the forward drive axle housing 22. Preferably, the through shaft 96 extends under the second forward drive axle 28, as shown in FIG. 3. Those skilled in the art will appreciate that the differential spider, pinions and side gears discussed above may have to be offset to one side of the forward drive axle housing 22 to provide sufficient clearance for the through shaft 96.

The through shaft 96 has a male portion 100 designed to fit within a female portion 102 of a shaft 104. Preferably, the male portion 100 is free to rotate within the female portion 102.

It is also preferred that a clutch 106 selectively joins the through shaft 96 with the shaft 104. In a preferred embodiment depicted in FIG. 3, the clutch 106 comprises a clutch gear 108 located on a portion 110 of the through shaft 96 for rotation therewith and a complementary clutch gear 112 located on the shaft 104.

A portion of the complementary clutch gear 112 is connected to a shift fork 114. The shift fork 114 may be hydraulically driven, or pneumatically driven. It is also within the scope of the present invention for the shift fork 114 to be manually or electrically driven. The shift fork 114 is axially movable by a control means 116, thus bringing clutch gears 108, 112 into and out of engagement with one another. It can be appreciated that when clutch gears 108, 112 are brought into mesh with one another via the shift fork 114 and the control means 116, the shaft 104 rotates with the through shaft 96. When the control means 116 and shift fork 114 disengage the clutch gears 108, 112, the through shaft 96 no longer provides rotational drive to the shaft 104.

The shaft 104 is supported for rotation with respect to the forward drive axle housing 22 on at least one rear bearing. Preferably, two rear bearings 118 support the shaft 104. A seal 120 is located outwardly from the bearings 118 to prevent lubricant from escaping from the forward drive axle housing 22 and to prevent dirt and debris from entering the forward drive axle housing 22.

A yoke 84 is preferably attached to an end portion 124 of the shaft 104, as known by those skilled in the art. The yoke 84 is connected to the inter-axle driveline 36 described above and depicted in FIG. 1.

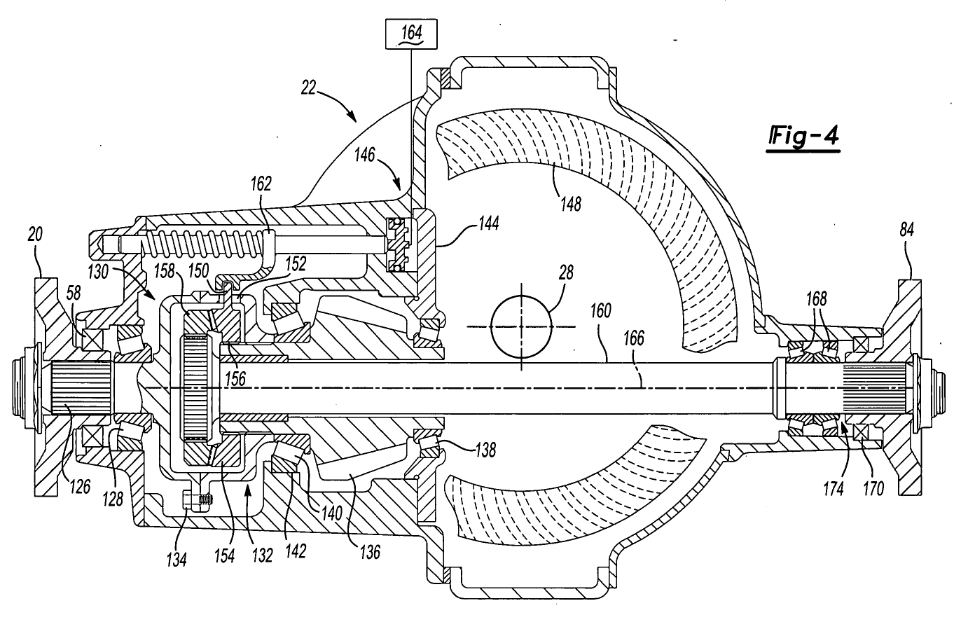

Referring now to FIG. 4, another embodiment of selected components of the forward drive axle housing 22 is depicted. Again, like reference numbers have been used for this embodiment for like structures discussed above. One half of the yoke 20 connecting the forward drive axles 26, 28 with the shaft 16 is depicted. The yoke 20 is mounted on an input shaft 126. The input shaft 126 is mounted for rotation within the forward drive axle housing 22 on at least one bearing 128.

A seal 58, as known by those skilled in the art, is located about the input shaft 126 to prevent dirt and debris from entering the forward drive axle housing 22 and to prevent lubricant (not shown) located within the forward drive axle housing 22 from escaping.

The input shaft 126 has an outwardly, radially extending flange 130. The flange 130 is secured to a cup 132 preferably with one or more mechanical fasteners 134. The flange 130 and the cup 132 may also be welded together or integrally formed together. The flange 130 therefore provides rotational drive to the cup 132. The cup 132 is drivingly connected to a pinion gear 136.

The pinion gear 136 is mounted for rotation within the housing 22 on an inner pinion gear bearing 138 and an outer pinion gear bearing 140. The outer pinion gear bearing 140 may be supported within the housing 22 with an integrally formed outer pinion gear bearing support 142, as shown in FIG. 4. The inner pinion gear bearing 138 may be supported within the housing 22 with a bolt-on cage 144, as also shown in FIG. 4. Those skilled in the art will appreciate other bearing support mechanisms and systems are within the scope of the present invention.

The input shaft 126 is preferably axially aligned with the pinion gear 136.

The pinion gear 136 is part of a hypoid gear set 146 also comprising a ring gear 148. The ring gear 148 is drivingly connected to a differential case (not shown), as known by those skilled in the art. The differential case is connected to a spider having at least one shaft with pinions located on the ends of the shaft. The pinions are connected to side gears (not shown), which are connected to the first and second forward drive axles 26, 28. Thus, drive is provided to the first and second forward drive axles 26, 28 as described above and as known by those skilled in the art.

At least one tab 150 extends radially outward through a slot 152 in the cup 132. A plurality of tabs or a circumferential ring may also be used. The tab 150 is preferably mounted on a clutch gear 154. The clutch gear 154 is slidable in the axial direction on a plurality of splines 156 on the pinion gear 136.

Another clutch gear 158 is mounted on a through shaft 160 so that clutch gear 158 is adjacent clutch gear 154. The tab 150 is connected to a shift fork 162. The shift fork 162 may be pneumatically driven, hydraulically driven, electrically driven or manually driven. Regardless of the means to drive the shift fork 162, it is connected to at least one control means 164.

The control means 164 axially moves the shift fork 162 which in turn moves the clutch gear 154 into or out of engagement with clutch gear 158. Engagement of the clutch gears 154, 158 causes the through shaft 160 to rotate with the input shaft 126. The pinion gear 136 is concentrically located about the through shaft 160 and the pinion gear 136 and through shaft 160 are free to rotate with respect to one another.

It can be appreciated, based on FIG. 4, that the input shaft 126, the through shaft 160 and the pinion gear 136 share the same axis of rotation 166 and are axially aligned with one another. Those skilled in the art will appreciate that the spider pinions and side gears discussed above may have to be offset to one side of the forward drive axle housing 22 to provide sufficient clearance for the through shaft 160.

The through shaft 160 extends across the forward drive axle housing 22. Preferably, the through shaft 160 extends under the second forward drive axle 28, as shown in FIG. 4.

The through shaft 160 is supported for rotation with respect to the forward drive axle housing 22 on at least one rear bearing. Preferably, two rear bearings 168 support the through shaft 160. A seal 170 is located outwardly from the bearings 168 to prevent lubricant from escaping from the forward drive axle housing 22 and to prevent dirt and debris from entering the forward drive axle housing 22.

A yoke 84 is preferably attached to an end portion 174 of the through shaft 160, as known by those skilled in the art. The yoke 84 is connected to the inter-axle driveline 36 described above and depicted in FIG. 1.

Those skilled in the art will note that, in the preferred embodiments of the forward drive axle housing 22 described above, helical drop gear components are not required. Also, only one differential is required due to the elimination of the power divider differential and elimination of the rear axle wheel differential, for the complete tandem axle set.

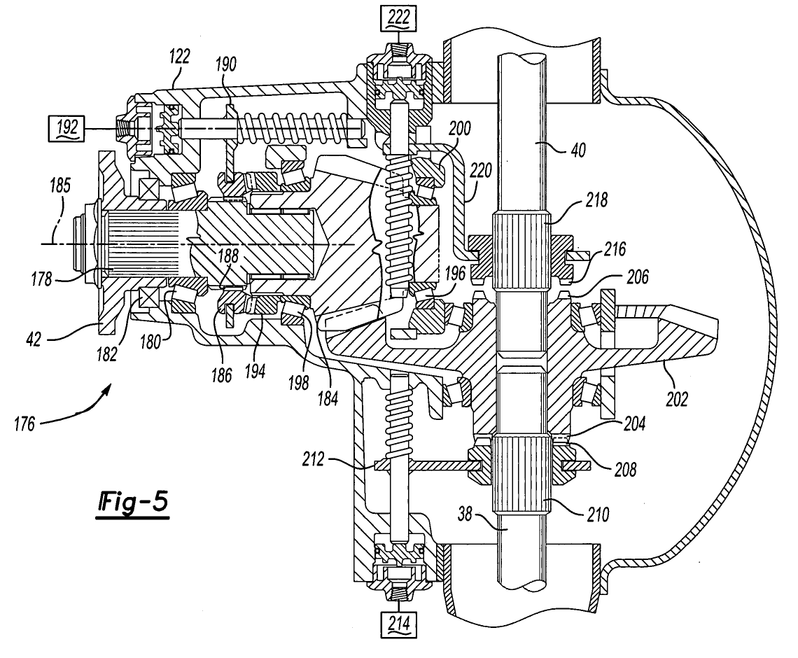

Referring now to FIG. 5, selected components within a rear drive axle housing 176 are depicted. An input shaft 178 having a yoke 42 for connection with the inter-axle drive line 36 is provided. The input shaft 178 is mounted for rotation within the rear drive axle housing 176 with at least one bearing 180. A seal 182 is preferably located about the input shaft 178 to prevent dirt and debris from entering into the rear drive axle housing 176 and to prevent lubrication (not shown) from escaping from the housing 176.

The input shaft 178 is connected to a rear pinion gear 184. Preferably, the input shaft 178 is located within the rear pinion gear 184, so that the rear pinion gear 184 is concentric with a portion of the input shaft 178. Of course, this arrangement puts the rear pinion gear 184 on the same rotational axis 185 as the input shaft 178. The input shaft 178 may rotate with the rear pinion gear 184 or separate therefrom.

A clutch gear 186 is mounted for rotation with the input shaft 178. Preferably, the clutch gear 186 is mounted on the input shaft 178 via splines 188 that allow the clutch gear 186 to move axially with respect to the input shaft 178. The clutch gear 186 is connected to a shift fork 190. The shift fork 190 is connected to a pneumatic, hydraulic, electric, and/or manual control means 192.

A complementary clutch gear 194 is located on the rear pinion gear 184 adjacent to clutch gear 186. Those skilled in the art will appreciate that the control means 192 can axially move the shift fork 190, thus axially moving clutch gear 186 into and out of engagement with clutch gear 194. Engagement of the clutch gears 186,194 results in rotational drive being supplied from the input shaft 178 to the rear pinion gear 184.

The rear pinion gear 184 is mounted for rotation within the housing 122 on at least one bearing. Preferably, the rear pinion gear 184 is mounted for rotation within the housing 122 on an inner pinion bearing 196 and an outer pinion bearing 198. The inner pinion bearing 196 may be mounted on bearing cage 200, as shown in FIG. 5.

The rear pinion gear 184 is connected to a rear ring gear 202. The rotational drive provided by the rear pinion gear 184, when it is drivingly connected to the input shaft 178, drives the rear ring gear 202.

As shown in FIG. 5, the rear ring gear 202 rotates about the first rear axle drive shaft 38 and the second rear axle drive shaft 40. Preferably, the rear ring gear 202 has a first set of clutch teeth 204 and a second set of clutch teeth 206.

The first set of clutch teeth 204 on the rear ring gear 202 are adjacent a clutch gear 208 mounted for rotation on the first rear axle drive shaft 38. Preferably, the clutch gear 208 is mounted on the first rear axle drive shaft 38 on a plurality of splines 210 that facilitate inward and outward movement of the clutch gear 208 with respect to the first rear axle drive shaft 38. The clutch gear 208 is connected to a shift fork 212. The shift fork 212 is controlled by a control means 214 that may be pneumatically, hydraulically, electrically or manually driven.

The control means 214 can move the shift fork 212 inwardly and outwardly thus moving the clutch gear 208 into and out of engagement with the first set of clutch teeth 204. Engagement of the first set of clutch teeth 204 with the clutch gear 208 provides rotational drive to the first rear axle drive shaft 38.

The second set of clutch teeth 206 on the rear ring gear 202 are adjacent a clutch gear 216 mounted for rotation on the second rear axle drive shaft 40. Preferably, the clutch gear 216 is mounted on the second rear axle drive shaft 40 on a plurality of splines 218 that facilitate inward and outward movement of the clutch gear 216 with respect to the second rear axle drive shaft 40. The clutch gear 216 is connected to a shift fork 220. The shift fork 220 is controlled by a control means 222 that may be pneumatically, hydraulically, electrically or manually driven.

The control means 222 can move the shift fork 220 inwardly and outwardly thus moving the clutch gear 216 into and out of engagement with the second set of clutch teeth 206. Engagement of the second set of clutch teeth 206 with the clutch gear 216 provides rotational drive to the second rear axle drive shaft 40. Preferably, the shift forks 212, 220 operate simultaneously with one another to provide identical rotational drive to the first rear axle drive shaft 38 and the second rear axle drive shaft 40.

It is within the scope of the present invention for the shift fork 190 to disengage clutch gear 186 with clutch gear 194 to prevent the pinion gear 184 from rotating with the input shaft 178. It is also within the scope of the present invention for the shift forks 212, 220 to disengage the first set of clutch teeth 204 with clutch gear 208 and to disengage the second set of clutch teeth 206 with clutch gear 216 to prevent the ring gear 202 from rotating.

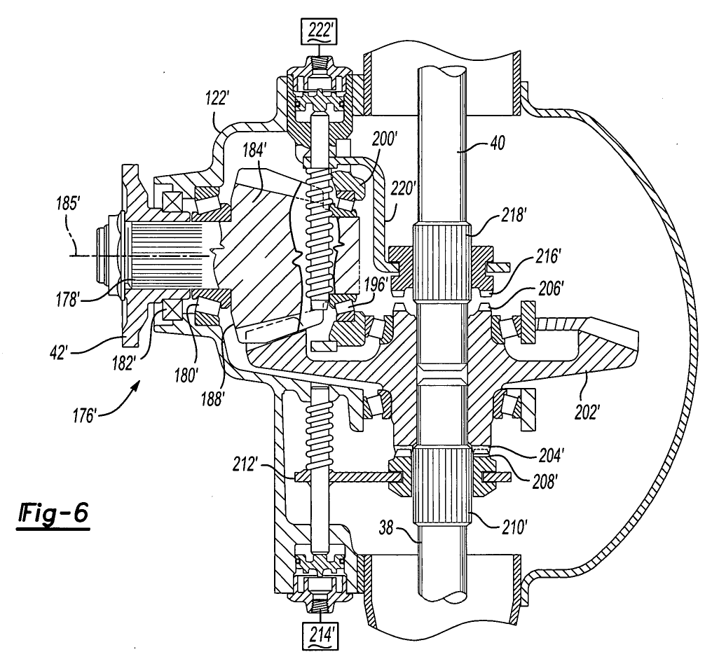

Referring now to FIG. 6, selected components within yet another embodiment of a rear drive axle housing 176′ are depicted. Certain components in FIG. 6 that are similar to components depicted in FIG. 5 are described above and designated with prime. Components which may be identical between FIGS. 5 and FIG. 6 use the same reference numbers without a prime designation.

An input shaft 178′ having a yoke 42′ for connection with the inter-axle drive line 36 is provided. The input shaft 178′ is mounted for rotation within the rear drive axle housing 176′ with at least one bearing 180′. A seal 182′ is preferably located about the input shaft 178′ to prevent dirt and debris from entering into the rear drive axle housing 176′ and to prevent lubrication (not shown) from escaping from the housing 176′.

The input shaft 178′ is connected to a rear pinion gear 184′. Preferably, the input shaft 178′ is located within the rear pinion gear 184′, so that the rear pinion gear 184′ is concentric with a portion of the input shaft 178′. Of course, this arrangement puts the rear pinion gear 184′ on the same rotational axis 185′ as the input shaft 178′.

The rear pinion gear 184′ is mounted for rotation within the housing 176′ on at least one bearing 180′. Preferably, the rear pinion gear 184′ is mounted for rotation within the housing 122′ on an inner pinion bearing 196′ and an outer pinion bearing 180′. The inner pinion bearing 196′ may be mounted on bearing cage 200′ as shown in FIG. 6.

The rear pinion gear 184′ is connected to a rear ring gear 202′. The rotational drive provided by the rear pinion gear 184′, when it is drivingly connected to the input shaft 178′, drives the rear ring gear 202′.

As shown in FIG. 6, the rear ring gear 202′ rotates about the first rear axle drive shaft 38 and the second rear axle drive shaft 40. Preferably, the rear ring gear 202′ has a first set of teeth 204′ and a second set of teeth 206′.

The first set of teeth 204′ on the rear ring gear 202′ are adjacent a clutch gear 208′ mounted for rotation on the first rear axle drive shaft 38. Preferably, the clutch gear 208′ is mounted on the first rear axle drive shaft 38 on a plurality of splines 210′ that facilitate inward and outward movement of the clutch gear 208′ with respect to the first rear axle drive shaft 38. The clutch gear 208′ is connected to a shift fork 212′. The shift fork 212′ is controlled by a control means 214′ that may be pneumatically, hydraulically, electrically or manually driven.

The control means 214′ can move the shift fork 212′ inwardly and outwardly thus moving the clutch gear 208′ into and out of engagement with the first set of teeth 204′. Engagement of the first set of teeth 204′ with the clutch gear 208′ provides rotational drive to the first rear axle drive shaft 38.

The second set of teeth 206′ on the rear ring gear 202′ are adjacent a clutch gear 216′ mounted for rotation on the second rear axle drive shaft 40. Preferably, the clutch gear 216′ is mounted on the second rear axle drive shaft 40 on a plurality of splines 218′ that facilitate inward and outward movement of the clutch gear 216′ with respect to the second rear axle drive shaft 40. The clutch gear 216′ is connected to a shift fork 220′. The shift fork 220′ is controlled by a control means 222′ that may be pneumatically, hydraulically, electrically or manually driven.

The control means 222′ can move the shift fork 220′ inwardly and outwardly thus moving the clutch gear 216′ into and out of engagement with the second set of teeth 206′. Engagement of the second set of teeth 206′ with the clutch gear 216′ provides rotational drive to the second rear axle drive shaft 40. Preferably, the shift forks 212′, 220′ operate simultaneously with one another to provide identical rotational drive to the first rear axle drive shaft 38 and the second rear axle drive shaft 40.

It is also within -the scope of the present invention for the shift forks 212′, 220′ to disengage the first set of teeth 204′ with clutch gear 208′ and to disengage the second set of teeth 206′ with clutch gear 216′ to prevent the ring gear 202′ from rotating.

Based upon the above-described preferred embodiment of the present invention, those skilled in the art will appreciate that a rear axle differential is not required. The rear ring gear 202, 202′, thus provides selective, direct drive to the first rear axle drive shaft 38 and the second rear axle drive shaft 40.

It must also be appreciated that the assembly described above and depicted in FIG. 2 can be mated to the assembly described above and depicted in FIG. 5 via the inter axle driveline 36. Further, it can be appreciated that the assemblies described above and depicted in FIGS. 3 or 4 can be mated to the assembly described above and depicted in FIG. 6 via the inter axle driveline 36.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A tandem axle system, comprising:
a forward drive assembly of a tandem axle system comprising a forward input shaft and a forward pinion gear axially aligned with and connected to said forward input shaft, said forward pinion gear directly driving a forward ring gear via a hypoid engagement;
a rear drive assembly of said tandem axle system comprising a rear pinion gear, said rear pinion gear connected to a rear ring gear and selectively connected to said forward drive assembly.

2. The system of claim 1, wherein said forward drive assembly further comprises a through shaft, said through shaft located beneath a forward drive axle shaft.

3. The system of claim 2, wherein said through shaft is connected to an inter-axle driveline, said inter-axle driveline connecting said forward drive assembly with said rear drive assembly.

4. The system of claim 3, wherein said through shaft is concentric with and drivingly connected to, said forward pinion gear.

5. The system of claim 3, wherein said through shaft is integrally formed with, and axially aligned with, said forward pinion gear.

6. The system of claim 5, wherein a clutch gear is secured to a portion of said through shaft for rotation therewith, said clutch gear secured to said through shaft in said forward drive assembly.

7. The system of claim 6, wherein an axially movable clutch gear is secured to a shaft for selective engagement with said clutch gear within said forward drive assembly.

8. The system of claim 7, wherein a fluid driven shift fork is connected to said axially moveable clutch gear on said shaft.

9. The system of claim 3, wherein said input shaft has a flange extending radially outwardly therefrom, said flange connected to a cup, said cup in driving engagement with said forward pinion gear.

10. The system of claim 9, wherein a clutch gear is connected to said cup and a fluid driven shift fork.

11. The system of claim 10, wherein a clutch gear is connected to a portion of said through shaft for selective engagement with said clutch gear connected to said cup.

12. The system of claim 3, wherein said inter-axle driveline is connected to a rear input shaft of said rear drive assembly and said rear input shaft is connected to said rear pinion gear.

13. The system of claim 12, wherein said rear input shaft is concentric with said rear pinion gear.

14. The system of claim 12, wherein a clutch gear is attached to said rear input shaft for rotation therewith, said clutch gear being attached to a fluid driven shift fork.

15. The system of claim 12, wherein a clutch gear is attached to said rear pinion gear, said clutch gear selectively meshing with said rear input shaft gear to drive said rear pinion gear.

16. The system of claim 3, wherein said rear ring gear is selectively connected to a first rear drive axle shaft and a second rear drive axle shaft.

17. The system of claim 16, wherein said rear ring gear has a first clutch gear and a second clutch gear.

18. The system of claim 17, wherein said first rear drive axle shaft has a clutch gear attached thereto, said clutch gear being selectively movable along said first rear drive axle shaft by a fluid driven shift fork for engagement with said first gear of said ring gear.

19. The system of claim 17, wherein said second rear drive axle shaft has a clutch gear attached thereto, said clutch gear being selectively moveable along said second rear drive axle shaft by a fluid driven shift fork for engagement with said second clutch gear of said ring gear.

20. A tandem axle system, comprising:
a forward drive assembly comprising an input shaft and a forward pinion gear, said forward pinion gear being axially aligned with both said input shaft and a through shaft, said forward pinion gear having a hypoid engagement with a forward ring gear for driving a first forward drive axle shaft and a second forward drive axle shaft, said hypoid engagement allowing said through shaft to pass beneath both of said forward axle shafts; and
a rear drive assembly comprising a rear pinion gear connected to said through shaft and to a rear ring gear, said rear ring gear mounted on a first rear drive axle shaft and a second rear drive axle shaft for selectively providing direct drive to said first rear drive axle shaft and said second rear drive axle shaft.

21. A tandem axle system, comprising:
a forward drive assembly having a hypoid gear set comprising a forward pinion gear directly driving a forward ring gear, said forward pinion gear axially aligned with an input shaft;
a through shaft connected to, and axially aligned with, said forward pinion gear;
a rear drive assembly connected to said through shaft with an inter-axle driveline; and
at least one clutch for selectively engaging and disengaging said rear drive assembly.

22. The system of claim 21, wherein said clutch is located in a forward drive axle housing.

23. The system of claim 21, wherein said clutch is located in a rear drive axle housing.
